(19) United States
(12) Patent Application Publication
(10) Pub. No.: US 2008/0307800 A1
(43) Pub. Date: Dec. 18, 2008

(54) Siphon for Delivery of Liquid Cryogen from Dewar Flask

(75) Inventors: Alexander LEVIN, Binyamina (IL); Didier TOUBIA, Raanana (IL); Miron KAGANOVICH, Haifa (IL)

Correspondence Address: HESLIN ROTHENBERG FARLEY & MESITI PC, 5 COLUMBIA CIRCLE, ALBANY, NY, 12203, US

(73) Assignee: ARBEL MEDICAL LTD., Yokneam (IL)

(21) Appl. No.: 11/763,093

(22) Filed: Jun. 14, 2007

(51) Int. Cl. F17C 6/00

(52) U.S. Cl. 62/50.7; 62/50.1

(57) ABSTRACT

The invention involves a siphon for delivery of a liquid cryogen from a container such as a Dewar flask. The siphon ensures delivery of a liquid cryogen with a lower proportion of the gaseous fraction. The siphon comprises a central feeding conduit, which is largely contained within the Dewar flask. There is an auxiliary conduit surrounding the central feeding conduit; the outer upper section of this auxiliary conduit is provided with an adjustable valve intended to release a gaseous fraction of the cryogen contained in the annular gap between the auxiliary and central feeding conduits. The upper section of the central feeding conduit is provided with an external layer of a porous capillary coating or with a wick; this ensures that the upper section of the central feeding conduit is continuously wetted with the liquid cryogen. This porous capillary coating prevents gasification of the liquid cryogen in the central feeding conduit. Alternatively, the problem of liquid cryogen gasification may be solved through thermal insulation of the central feeding conduit.

### FIELD OF THE INVENTION

The invention relates to cryogen devices and, in particular, to a Dewar flask siphon which ensures delivery of a high quality of liquid cryogen even for low values of the flow rate.

### BACKGROUND OF THE INVENTION

Siphons intended for feeding a liquid cryogen contained in a Dewar flask are known in the art, although all suffer from various drawbacks, particularly as they increase the amount of gas generated from the liquid cryogen as it becomes heated.

For example, Tsals (U.S. Pat. No. 6,012,453) describes an apparatus that provides for withdrawal of the liquid contents from a closed container independent of the spatial orientation thereof. The liquid withdrawal apparatus includes flexible withdrawal conduits disposed inside the container and in fluid flow communication with external heat exchangers. The heat exchangers serve to transfer heat to the withdrawn liquid to thereby provide a breathable gas mixture. The upstream end of the withdrawal conduits are provided with a weighted pick-up means comprising a wicking material that draws liquid into the interior thereof to ensure contact of the liquid with the conduits, even when the supply of liquid is nearly depleted. A pressure differential between the inside of the container and the external heat exchangers, normally brought about by an inhalation event of the user, provides the motive force for withdrawing the liquid contents from the container through the conduits. Thus, this solution is clearly intended to generate gas not to block the generation thereof.

James (U.S. Pat. No. 5,417,073) teaches a portable Dewar flask for cooling an object through use of cryogenic fluids comprising a reservoir for holding cryogenic fluid. The reservoir includes a fill port, a wicking material adapted to be in thermal contact with the object to be cooled, a transfer tube connected between and coupling the reservoir and the wicking material to permit transfer of the cryogenic fluid from the reservoir to the wicking material and a venting channel adjacent the reservoir for providing a vent for evaporated cryogenic fluid from the wicking material. The evaporated cryogenic fluid has thermal contact with the reservoir. An outer wall defines a vacuum space circumferentially surrounding the reservoir, venting channel and wicking material. Again, the solution for gas generation is merely to vent the gas from the system.

Caldwell (U.S. Pat. No. 5,438,837) discloses an apparatus for storing and delivering a liquid cryogen. The apparatus is a Dewar flask having a rotating liquid cryogen intake, a rotating gas supply vent, and a rotating capacitance gauge. Also disclosed are a system and a process employing the system for liquefying a gas to produce a liquid cryogen in the Dewar flask wherein the gas is subcritically cooled and then condensed in the pressure vessel of the Dewar flask. Again, the solution to the problem of gas generation is simply to vent the gas.

Caldwell (U.S. Pat. No. 5,361,591) describes a portable life support system, comprising: a liquid cooled garment; an orientationally independent Dewar flask for containing liquid cryogen; means for circulating liquid cryogen from the Dewar flask in heat exchange relation with the cooling liquid so as to cool the wearer of the garment and vaporize the liquid cryogen; and means for delivering vaporized cryogen to the wearer of the garment for breathing purposes. This solution is actually intended for gas generation, which is considered to be desirable in this context.

Cowans (U.S. Pat. No. 3,699,775) describes a liquid processing system, featuring a container including a liquid and a pressurizing gas which is substantially non-reactive with respect to the liquid and which establishes a controlled pressure differential between the interior of the container and its surroundings. A porous conduit, extending between the interior and exterior of the container, is maintained in contact with the liquid. The conduit transports liquid along its length, forming a meniscus of extended surface upon portions of the conduit not submerged in the liquid. The meniscus defines a gas barrier; the conduit nevertheless transports fluid at a selected rate between the container and its surroundings. When employed in a cryogenic system, fluid may be transported in response to heat interchange by the container, the rate depending on the temperature change required. Yet again, this solution depends upon the use and generation of gas from the cryogenic liquid.

In addition, a Dewar flask siphon described in the book: Verkin B. I. et al. “.” LOW TEMPERATURES IN STOMATOLOGY”, Naukova Dumka, Kiev, 1990, pp.62÷63

(originally in Russian) should be noted. This book proposes a siphon design, which is based on application of a finned external housing and a jacket surrounding the central feeding conduit The gap between the jacket and the central feeding conduit is filled with liquid-gaseous mixture of cryogen. In addition, this liquid-gaseous mixture of cryogen enters via a set of holes on the internal surface of the finned housing with further evaporation. It causes, in turn, quick elevation of pressure in the internal space of the dewar flask. However, this design does not solve the problem of the low quality of the liquid cryogen supplied from the central feeding conduit for low magnitudes of the supply rate of the liquid cryogen.

### SUMMARY OF THE INVENTION

None of the above background art references teaches or describes a design of a Dewar flask siphon which ensures delivery of high quality of liquid cryogen even for low values of the flow rate. Furthermore, none of the above background art references teaches or describes a Dewar flask siphon which reduces the amount of gas generated from the liquid cryogen.

The present invention overcomes these drawbacks of the background art by providing a siphon system for a container such as a Dewar flask, which ensures delivery of high quality of a liquid cryogen even for low values of the flow rate.

According to preferred embodiments of the present invention, the siphon ensures delivery of a liquid cryogen with a lower proportion of the gaseous fraction as compared to other siphon/Dewar flask systems which are known in the art. The siphon comprises a central feeding conduit, which is preferably largely positioned within the Dewar flask such that at least about 50% and more preferably at least about 60%, and most preferably at least about 75% of the central feed conduit is positioned within the Dewar flask. Preferably an external (auxiliary) conduit surrounds the central feeding conduit; and, the outer upper section of this auxiliary conduit is preferably provided with a port and an adjustable valve intended to release a gaseous fraction of the cryogen contained in the annular gap between the auxiliary and central feeding conduits.

The upper section of the central feeding conduit preferably features an external layer of a porous capillary coating or with a wick, or any other type of capillary material, for wetting the upper section of the central feeding conduit with the liquid cryogen. This capillary material wetted with the liquid cryogen prevents gasification of the liquid cryogen in the central feeding conduit. Alternatively, the problem of liquid cryogen gasification may be solved through thermal insulation of the central feeding conduit, as described according to some embodiments of the present invention.

According to preferred embodiments of the present invention, the siphon system comprises: an external (auxiliary) conduit, its lower section is situated in the Dewar flask and the upper section is located outside the Dewar flask; a sealing unit, preferably in the form of a annular rubber ring, which allows installation of the siphon in the Dewar flask neck and a section of the tubular piece is joined sealingly with the annular rubber ring; and a central feeding conduit, wherein part of this central feeding conduit is positioned in the aforementioned external conduit and its lower end is situated substantially near the bottom of the internal space of the Dewar flask. The upper edge of the external conduit is sealed with the outer section of the central feeding conduit.

According to some embodiments, a capillary wicking structure is situated at least between the upper sections of the external and central feeding conduits. This capillary wicking structure has such characteristics (length and size of the capillary open pores) that wetting its lower edge with the liquid cryogen ensures wetting the whole capillary wicking structure with liquid cryogen. Preferably, there is also provided a mechanism and/or system for maintenance of a proper level of the liquid cryogen in the annular gap between the external and central feeding conduits, such that the lower section of the capillary wicking structure is wetted by the liquid cryogen in the Dewar flask on one hand, and flooding this annular gap by the liquid cryogen is prevented on the other hand; various non-limiting examples of suitable mechanisms and/or systems are described herein.

Optionally and preferably the external conduit is surrounded by a jacket, while the upper edge of the jacket is sealed with the external conduit. The jacket preferably is formed as a tubular piece.

Also optionally and preferably, a shut-off valve is installed on the outer section of the central feeding conduit. Optionally and preferably, safety and relief valves are installed on the outer section of the jacket. More preferably, the outer section of the external conduit is provided with an opening which is provided, in turn, with a duct, which most preferably features an adjustable valve installed thereto.

According to some embodiments, the jacket is provided with ports; and the device further features a pressure gauge for measuring pressure of the cryogen, a safety valve and a release valve communicating with a respective one of the ports of the jacket for reducing the pressure of the cryogen. Optionally and preferably, the jacket is provided with a port for introducing a suppressed gas into the Dewar flask. Also the siphon preferably features a gap between the jacket and the external conduit for increasing hydraulic resistance of cryogen flow.

Preferably, a pressure gauge is installed on the outer section of the jacket which serves for measuring pressure in the Dewar flask.

According to these preferred embodiments of the present invention, the capillary wicking structure provides thermal protection of the upper section of the central feeding conduit of the siphon by evaporation of the liquid cryogen from the external side of this central feeding conduit; this evaporation occurs with a rate which matches the rate of the heat influx from the outside sources at this section.

A capillary wicking structure may optionally be fabricated as a wick from thin fibers maintained on the outer wall of the central feeding conduit. Alternatively, this capillary wicking structure may optionally comprise a porous coating from a sintered metal powder.

According to optional but preferred embodiments of the present invention, there is optionally and preferably provided a measuring system for determining a level of the liquid cryogen in the annular gap between the external and central feeding conduits and preferably for ensuring a proper and sufficient level thereto. The measuring system also optionally and preferably comprises a control unit. More preferably, the control unit (according to the measured level) causes the adjustable valve to release evaporated gas from the annular gap between the external and central feeding conduits at a sufficient rate to ensure wetting of the lower edge of capillary wicking structure by the liquid cryogen. Alternatively or additionally and most preferably, the control unit controls the adjustable valve activity in order to prevent or at least alleviate overflowing the gap between the external and central feeding conduits by liquid cryogen. Alternatively or additionally, the adjustable valve may optionally be controlled manually.

According to one optional embodiment, the measuring system preferably comprises a level gauge, which is positioned in the annular gap between the external and central feeding conduit and indicates a level of the liquid cryogen in this gap.

According to another optional embodiment, the measuring system preferably comprises a temperature measuring device for measuring the temperature of the gas released from the port of the annular gap, which optionally and preferably measures the temperature of the gaseous-liquid medium released from the space between the central feeding conduit and the external conduit.

According to yet another optional embodiment, the measuring system preferably comprises a density measuring device for measuring the density of the mist emitted from the port of the annular gap. For example, this device may optionally comprise an optical or ultrasound measuring unit. The optical device measures scattering of light by the mist, and the ultrasound device measures absorption of ultrasound by the mist depending on concentration of droplets in this mist. Optionally and preferably, the siphon features an optical measuring device for measuring density of an exhausted medium, which more preferably measures density of an exhausted medium from the space between the central feeding conduit and the external conduit. Alternatively or additionally, and optionally and preferably, the measuring means comprises an acoustical measuring device for measuring density of an exhausted medium, which more preferably measures density of an exhausted medium from the space between the central feeding conduit and the external conduit.

The lower edge of the central feeding conduit may optionally be provided with a filter in order to collect mechanical particles contained in the supplied liquid cryogen.

The lower section of the internal surface of the external jacket can be provided with a divider for dividing the upper and lower internal space of the Dewar flask, with the divider featuring high hydraulic resistance for passage of the gas through it. This prevents the liquid cryogen in the Dewar flask from being forced up and out in the case of opening the relief valve of the siphon. The divider may optionally comprise an internal threading of the external jacket with the internal diameter, which fits the outer diameter of the external conduit. Such an embodiment enables the spiral groove of the threading to present a high hydraulic resistance, which prevents boiling and overflow of the liquid cryogen in the Dewar flask when opening the relief valve.

In addition, the system may optionally and preferably comprise a check valve with a heat exchanger on the upper section of the central feeding conduit (before or after the shut-off valve), for optionally and preferably providing a pulse-wise supply of liquid cryogen on the expense of fast evaporation of a certain fraction of the liquid cryogen in the heat exchanger.

If the check valve is installed after the shut-off valve, it is possible to heat pulses of the liquid cryogen provided from the dewar flask in order to enhance pressure of the supplied pulses of the cryogen. In order to achieve this, preferably a low inertia electrical heater is installed immediately after the check valve and a low inertia temperature sensor is installed in the central feeding conduit. Delivery of a portion of the liquid cryogen via the check valve lowers the temperature as measured by the temperature sensor, which preferably sends a signal into a control power unit. This control-power unit preferably generates a pulse of electrical current, which is provided to the low inertia electrical heater and it causes the liquid cryogen to boil with a subsequent sharp elevation of its pressure, preferably through flash boiling. As a result, the check valve is closed and the high pressure portion of the liquid-gaseous cryogen is emitted.

According to some embodiments, the Dewar flask siphon allows elevation of the pressure of the liquid cryogen supplied from it without application of expensive cryogenic pumps. This improvement is based on compression of the evaporated gas from the annular gap by a compression means with following condensation of this compressed gas in a heat exchanger of the recuperative type. The amount of the evaporated gas to be compressed is chosen in such a manner that the amount of the liquid cryogen supplied from the central feeding conduit is able to condense the evaporated pressurized gas completely.

The condensed pressurized cryogen may optionally be provided from the heat exchanger in the form of pulses by application of a controllable valve, which is installed on the conduit communicating the compression means with the heat exchanger. This version presents another technical solution of obtaining high pressure pulses of cryogen in contrast with the design of a cryosurgical system described in Levin (U.S. Pat. No. 7,137,978) , wherein it teaches that pulses of the liquid cryogen were obtained by application of a multi-way valve and a balloon with pressurized gas was used as propulsion agent for portions of liquid cryogen, in contrast to the present invention.

The check valve can be incorporated as well into the distal upper section of the central feeding conduit situated in the Dewar flask, when the upper edge of the aforementioned capillary wicking structure is positioned somewhat lower than the check valve. The upper section of central feeding conduit, which communicates the check and shut-off valves, serves in this case as the aforementioned heat exchanger.

In addition, the proposed siphon can be provided with an inlet port in its jacket for introducing pressurized gas into the Dewar flask in order to establish a required pressure in it.

According to other preferred embodiments of the present invention, a gaseous cryogen at low temperature or a gas-liquid cryogenic mixture, which is removed from the annular gap between the external and central feeding conduits, can be used for cooling the interior of a hose, which serves for transportation of the liquid cryogen from the siphon. In this case the hose preferably comprises two conduits with a thermal insulation, which fills the internal space between these conduits and the external shaft of the hose. The main conduit serves for transportation of the liquid cryogen from the central feeding conduits and the auxiliary conduit serves for transportation of the cold cryogenic gas or liquid-gas cryogenic mixture from the annular gap between the external and central feeding conduits with resulting cooling the interior of the hose. Optionally and preferably, the hose transporting liquid cryogen from the Dewar flask comprises an envelope and a main conduit in flow communication with said central feeding conduit. More preferably, the hose further comprises an internal auxiliary conduit intended for the exhausted gaseous-liquid mixture from the space between the central feeding conduit and the external conduit; the distal end of the internal auxiliary conduit being in flow communication with an outer auxiliary conduit for releasing the cryogen into the atmosphere.

The main and auxiliary conduits can be positioned in the hose in parallel side by side or coaxially.

According to other embodiments of the present invention, gasification of the liquid cryogen in the upper section of the central feeding conduit of the siphon may optionally be based on application of thermal insulation of the upper section of this central feeding conduit, such as for example a vacuum induced insulation of the upper section. For this embodiment, the aforementioned check valve is optionally and preferably installed on the central feeding conduit in the vicinity of the upper edge of the thermal insulation.

According to preferred embodiments of the present invention, thermal insulation is preferably provided around the upper section of the central feeding conduit, which more preferably comprises a vacuum insulation.

According to preferred embodiments of the present invention, a check valve is installed after the shut-off valve in the direction of flow, wherein the device further comprises a low inertia electrical heater installed immediately after the check valve in the direction of flow; a low inertia temperature sensor installed in the central feeding conduit; and a control power unit receiving signals from the low inertia temperature sensor and generating pulses of electrical current provided to the low inertia electrical heater. Most preferably, the low inertia temperature sensor is a low inertia thermocouple.

### BRIEF DESCRIPTION OF THE DRAWINGS

FIG. 1a and FIG. 1b show an axial cross-sectional view of a Dewar flask with a siphon installed in its neck and an enlarged axial cross-sectional view of the upper section of the Dewar flask and the siphon.

FIG. 2 shows an axial cross-sectional view of a siphon with a capillary wick in its annular gap between the external and central feeding conduits.

FIG. 3a and FIG. 3b show an axial cross-sectional view of a siphon with a level gauge in its annular gap between the external and central feeding conduits, and an enlarged axial cross-sectional view of the upper section of the siphon.

FIG. 4a and FIG. 4b show an axial cross-sectional view of a siphon with a control unit, which is functioning on the base of measuring temperature of the gaseous-liquid mixture released from the annular gap between the external and central feeding conduits, and an enlarged axial cross-sectional view of the upper section of the siphon.

FIG. 5a and FIG. 5b show an axial cross-sectional view of a Dewar flask with a siphon installed in its neck and a hose with main and auxiliary conduits and an enlarged axial cross-sectional view of the upper section of the siphon, and the Dewar neck.

FIG. 6a and 6b show radial cross-sectional views of two possible constructions of the hose with the main and auxiliary conduits positioned in its internal space.

FIG. 7a and FIG. 7b demonstrate an axial cross-sectional view of a Dewar flask with a siphon; in addition there are a compression means, a valve means and a heat exchange means intended to provide high pressure pulses of the liquid cryogen, and an enlarged axial cross-sectional view of the upper section of the siphon, and the Dewar neck.

FIG. 8 shows an axial cross-sectional view of a siphon with a thermal insulation of the upper internal section of the central feeding conduit.

FIG. 9a and FIG. 9b show an axial cross-section of a Dewar flask with a siphon installed in its neck (FIG. 9a) and an enlarged axial cross-sectional view of the upper section of the siphon (FIG. 9b); a central feeding conduit of the siphon is provided with a vacuum evacuated jacket and a check valve.

FIG. 10a and FIG. 10b show an axial cross-sectional view of a siphon with a control unit, which measures a density of the mist emitted from the port of the annular gap between the external and central feeding conduits, and an enlarged axial cross-sectional view of the upper section of the siphon.

FIG. 11a and FIG. 11b show an axial cross-section of a Dewar flask with a siphon installed in its neck (FIG. 11a) and an enlarged axial cross-sectional view of the upper section of the siphon (FIG. 11b), with a low inertia temperature sensor and an electrical heater.

### DESCRIPTION OF PREFERRED EMBODIMENTS

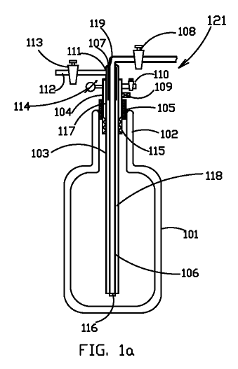

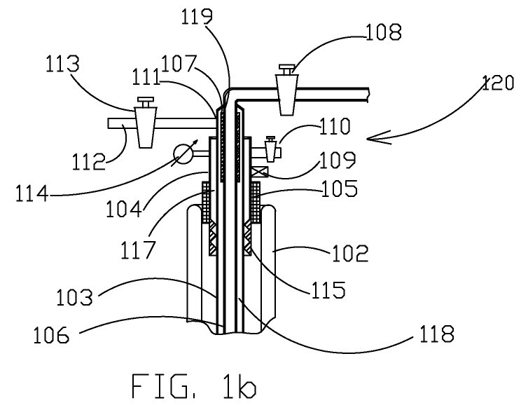

FIG. 1a and FIG. 1b show an axial cross-sectional view of an exemplary Dewar flask with a siphon installed in its neck according to preferred embodiments of the present invention, and an enlarged axial cross-sectional view of the upper section of the Dewar flask and the siphon. FIG. 1A shows a Dewar flask 101 with neck 102, which is intended to be filled with a liquid cryogen to be supplied by the siphon 121; FIG. 1B shows an expanded view of neck 102 and the upper siphon sections 120. Siphon 120 comprises an external conduit 103 and jacket 104 surrounding the external conduit 103 with gap 117 formed between them. The upper edge of jacket 104 is sealed with the external conduit 103 as shown. Siphon 121 also features an central feeding conduit 106 with gap 118 between the central feeding conduit 106 and the external conduit 103; this central feeding conduit serves for supply of the liquid cryogen to a target place. There is also a seal for sealing jacket 104 to the Dewar flask, an there is an annular rubber ring 105 installed on jacket 104 and inserted partially into neck 102, for holding siphon 121 in Dewar flask 101. The upper section 119 of the outer surface of the central feeding conduit 106 is preferably covered with a cryogen absorbing or wettable material, preferably a capillary material 107, which may optionally and preferably be a capillary coating. As shown, in the preferred embodiment, the capillary material is situated between the upper sections of said internal and external conduits. The upper edge of the external conduit 103 is sealed with the outer section of the central feeding conduit 106 as shown. Also, preferably a shut-off valve 108 is installed on the outer section of the central feeding conduit 106. The shut-off valve 108 ensures control of the supply of the liquid cryogen. Additionally, an outer section of the external conduit 103 includes at least one port and at least one corresponding valve 113 for releasing a gaseous-liquid cryogenic mixture from a space between the central feeding conduit 106 and the external conduit 103. This provides a required level of elevation of the liquid cryogen in gap 118, which provides wetting the capillary material 107.

In the preferred embodiment, preferably safety and relief valves 109 and 110 are installed on ports of the outer section of jacket 104 for this purpose. Jacket 104 also preferably features a pressure gauge 114 which is installed on the outer section of the external conduit 103 for measuring internal pressure in the Dewar flask 101. The outer section of the external conduit 103 is preferably provided with port 111 which is preferably provided in turn with duct 112, more preferably featuring the adjustable valve 113 for controlling wetting of the capillary material 107.

The lower section of the internal surface of jacket 104 is provided with an internal threading 115 with an internal diameter, which fits the outer diameter of the external conduit 103.

The lower end of the central feeding conduit 106 is provided with filter 116 in order to prevent ingress of solid particles into it.

With opening the adjustable valve 113, the level of liquid cryogen in the gap between the external conduit 103 and the central feeding conduit 106 rises which wets the capillary material 107. As a result, the temperature of the upper section of the central feeding conduit is lowered to the temperature of liquid cryogen and, after opening the shut-off valve 108, liquid cryogen of high quality is supplied into the central feeding conduit 106. By “high quality” it is meant that the liquid cryogen has relatively low amounts of gas present.

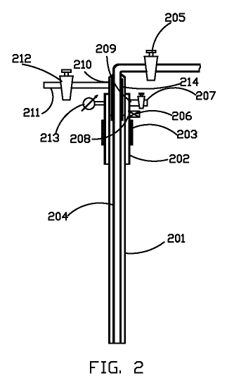

FIG. 2 shows an axial cross-sectional view of a siphon with a capillary wick in the gap between the external and central feeding conduits. As shown, this preferred embodiment of the present invention features an external conduit 201 and jacket 202 surrounding the external conduit 201. The upper edge of jacket 202 is sealed with the external conduit 201. An annular rubber ring 203 is preferably installed on jacket 202 as for FIG. 1a and FIG. 1b. The external conduit 201 surrounds the section of the central feeding conduit 204, preferably covered (at least at the upper section 214 of its outer surface) with a liquid cryogen absorbing or wettable material which is preferably a capillary material 214. The upper edge of the external conduit 201 is sealed with the outer section of the central feeding conduit 204.

A shut-off valve 205 is preferably installed on the outer section of the central feeding conduit 204, while safety and relief valves 206 and 207 are preferably installed on ports 208 and 209 of the outer section of jacket 202. Also, the outer section of the external conduit 201 is preferably provided with duct 210 which is provided in turn with a duct 211, more preferably featuring an adjustable valve 212. A pressure gauge 213 is preferably installed on the outer section of jacket 202, which more preferably serves for measuring pressure in a Dewar flask. These components preferably function as described for FIG. 1.

This exemplary illustrative embodiment of a siphon in combination with a dewar flask filled with a liquid cryogen preferably functions as follows.

Upon opening the adjustable valve 212, the level of liquid cryogen in the gap between the external conduit 201 and the central feeding conduit 204 is elevating, with wetting the capillary material 214. As a result, the temperature of the upper section of the central feeding conduit 204 is reduced to the temperature of the liquid cryogen and, after opening the shut-off valve 205, liquid cryogen of high quality is supplied into the outer section of the central feeding conduit 204. The level of the liquid nitrogen in the gap between the external conduit 201 and the central feeding conduit 204 is maintained by manually adjusting the adjustable valve 212, for example according to the visual characteristics of the liquid-gaseous mixture of the cryogen emitted from the adjustable valve 212.

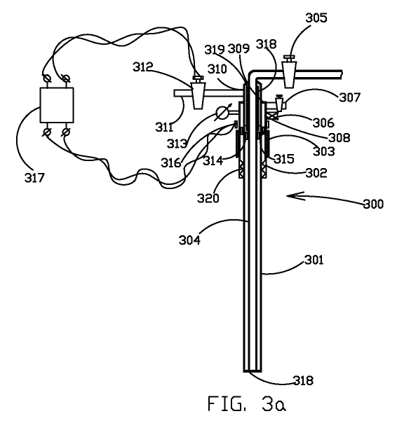

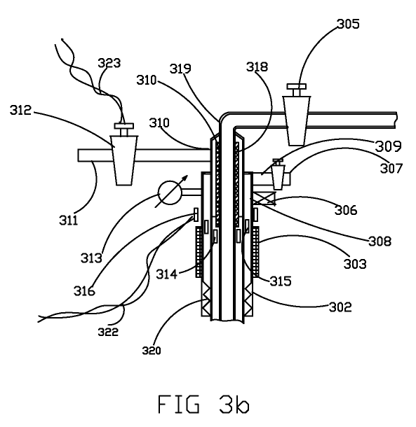

FIGS. 3A and 3B show an axial cross-sectional view of a siphon according to other preferred embodiments of the present invention with a level gauge in the gap between the external and central feeding conduits, and an enlarged axial cross-sectional view of the upper section of the siphon.

Siphon 300 preferably comprises an external conduit 301 and jacket 302 surrounding the external conduit 301. The upper edge of jacket 302 is sealed with the external conduit 301. An annular rubber ring 303 is preferably installed on jacket 302 as for FIG. 1a and FIG. 1b. The upper section 319 of the outer surface of the central feeding conduit 304 is preferably covered with a liquid cryogen absorbing or wettable material, preferably a capillary material 318, which may optionally be a capillary coating. The upper edge of the external conduit 301 is sealed with the outer section of the central feeding conduit 304.

A shut-off valve 305 is preferably installed on the outer section of the central feeding conduit 304, while safety and relief valves 306 and 307 are preferably installed on ports 308 and 309 of the outer section of jacket 302. The outer section of the external conduit 301 is preferably provided with port 310 which is provided in turn with duct 311, more preferably featuring an adjustable valve 312. A pressure gauge 313 is preferably installed on the outer section of jacket 302 for measuring the internal pressure in the Dewar flask. These components preferably operate as described for FIGS. 1a and 2.

The lower section of the internal surface of jacket 302 is preferably provided with an internal threading 320 with an internal diameter which fits the outer diameter of the external conduit 301. The lower end of the central feeding conduit 304 is preferably provided with a protecting grid 321 in order to prevent penetration of solid particles.

A level gauge 314 preferably interacts with an induction coil 316, more preferably through magnet 315 (which is optionally and more preferably an annular magnet). The induction coil 316 sends, in turn, a signal to a control unit 317 via cables 322 for regulating the activity of the adjustable valve 312. The adjustable valve 312 is controlled according to signals sent through cables 323 in order to achieve a desirable level of liquid cryogen in the annular gap between the external conduit 301 and the central feeding conduit 304; this level enables the capillary material 318 to be wetted without flooding the gap.

The preferred embodiment of the siphon in combination with a Dewar flask filled with a liquid cryogen preferably functions as follows. After opening the adjustable valve 312, the level of the liquid cryogen in the gap between the external conduit 301 and the central feeding conduit 304 is elevated such that the capillary material 318 is wetted. Once sufficient cryogen has entered, the level gauge 314 is elevated to a certain level. The level of the liquid cryogen in the gap between the external conduit 301 and the central feeding conduit 304 is maintained by the control unit 317, which closes and opens the adjustable valve 312 according to the signal provided by the induction coil 316 according to the level measured by the level gauge 314.

The temperature of the upper section of the central feeding conduit 304 is lowering to the temperature of the liquid cryogen and, after opening the shut-off valve 305, liquid cryogen of high quality is supplied into the outer section of the central feeding conduit 304.

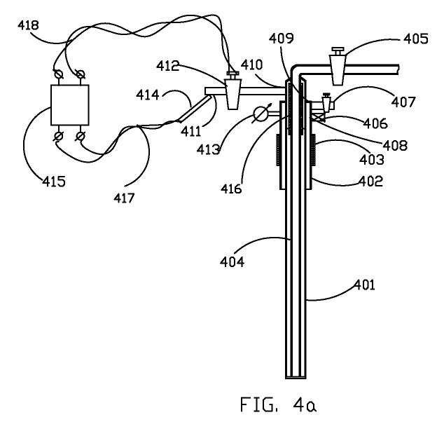

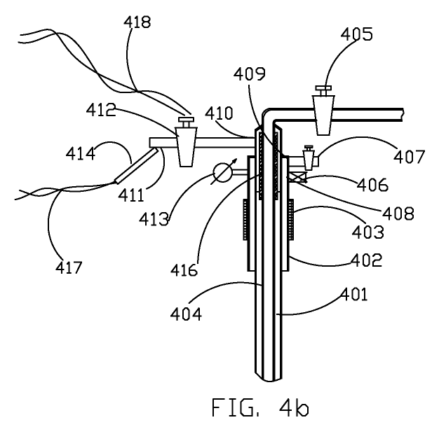

FIG. 4a and FIG. 4b show an axial cross-sectional view of a preferred embodiment of a siphon with a control unit, which operates on the basis of the temperature of the gaseous-liquid mixture released from the annular gap between the external and central feeding conduits (FIG. 4A), and an enlarged axial cross-sectional view of the upper section of the siphon (FIG. 4B).

This embodiment includes an external conduit 401; jacket 402 surrounding the upper section of the external conduit 401, wherein the upper edge of jacket 402 is sealed with the external conduit 401; an annular rubber ring 403; a central feeding conduit 404, wherein the upper section of its outer surface is coated with a capillary coating 416 and the upper edge of the external conduit 401 is sealed with the outer section of the central feeding conduit 404; a shut-off valve 405, which is installed on the outer section of the central feeding conduit 404; and safety and relief valves 406 and 407, which are installed on ports 408 and 409 of the outer section of jacket 402. The outer section of the external conduit 401 is provided with port 410 which is provided in turn with duct 411. There is an adjustable valve 412 installed on this duct. A pressure gauge 413, which is installed on the outer section of jacket 402, serves for measuring the pressure in the Dewar flask. These components correspond to similar components described with regard to FIGS. 1-3.

The siphon in combination with a dewar flask filled with a liquid cryogen preferably operates as follows. After opening the adjustable valve 412, the liquid cryogen in the gap between the external conduit 401 and the central feeding conduit 404 is elevated to a level which wets the capillary material 416. The temperature of the upper section of the central feeding conduit 404 is reduced to the temperature of the liquid cryogen and, after opening the shut-off valve 405, liquid cryogen of high quality is supplied into the outer section of the central feeding conduit 404. The level of the liquid cryogen in the gap between the external conduit 401 and the central feeding conduit 404 is maintained by the control unit 415 through cables 418, which closes and opens the adjustable valve 412 according to the signal provided by the temperature sensor 414 (measuring device) installed on duct 411; this signal is supplied to the control unit 415 through cables 417.

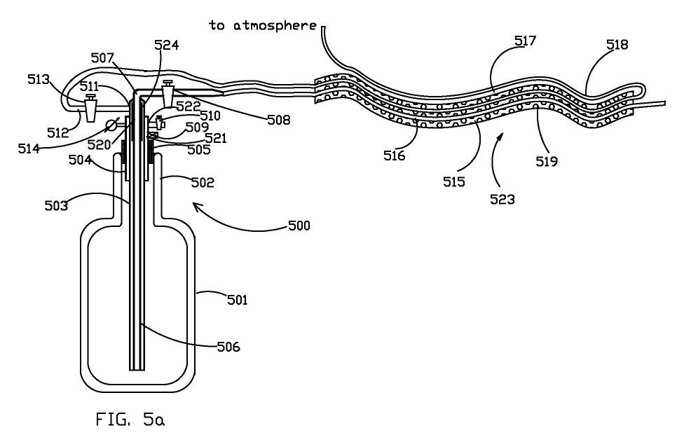

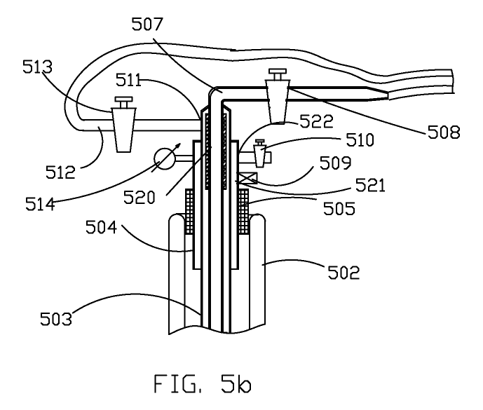

FIG. 5a and FIG. 5b show an axial cross-sectional view of preferred embodiments of a system according to the present invention, featuring a Dewar flask with a siphon installed in its neck and its associated siphon hose and an enlarged axial cross-sectional view of the upper section of the siphon, and the Dewar neck.

System 500 includes a Dewar flask 501 with neck 502, further comprising an external conduit 503 and jacket 504 surrounding the upper section of the external conduit 503. The upper edge of jacket 504 is sealed with the external conduit 503. An annular rubber ring 505 is installed on the outer surface of jacket 504 and is partially inserted into neck 502 for sealing thereto. There is a central feeding conduit 504; a large fraction of the central feeding conduit is surrounded by the external conduit 503. The upper section 520 of the outer surface of central feeding conduit 506 is preferably covered with a liquid cryogen absorbing or wettable capillary material 524, which may optionally be a capillary coating. The upper edge of the external conduit 503 is sealed with the outer section of the central feeding conduit 506.

A shut-off valve 508 is preferably installed on the outer section of the central feeding conduit 506, while safety and relief valves 509 and 510 are preferably installed on ports 521 and 522 of the outer section of jacket 504. The outer section of the external conduit 503 is preferably provided with opening 511 which is provided in turn with a duct 512, more preferably featuring an adjustable valve 513.

A pressure gauge 514 is preferably installed on the outer section of jacket 504 for measuring the internal pressure in a Dewar flask 501. The above components are similar in function to those described above.

According to preferred embodiments of the present invention, hose 523 is provided for transporting liquid cryogen from the Dewar flask 501.

Hose 523 preferably comprises: envelope 515; a main conduit 516, which is in flow communication with the central feeding conduit 506; and an internal auxiliary conduit 517, which is in flow communication with duct 512. The distal end of the internal auxiliary conduit 517 is in flow communication with an outer auxiliary conduit 518, which serves for release of the gas phase of the cryogen into the external atmosphere. The internal space of envelope 515 of hose 523 (between the other components of hose 523 as shown herein) is preferably filled with a thermo-insulating filler 519.

Upon opening the adjustable valve 513, the level of liquid cryogen in the gap between the external conduit 503 and the central feeding conduit 506 is elevated and thereby wets the capillary material 524. As a result, the temperature of the upper section of the central feeding conduit is reduced to the temperature of liquid cryogen and, after opening the shut-off valve 508, liquid cryogen of high quality is supplied into the outer section of the central feeding conduit 506. The liquid gaseous mixture of the cryogen from duct 512 enters hose 523 through the internal auxiliary conduit 517 and the outer auxiliary conduit 518, and the gas phase is exhausted into the external atmosphere. Regulation of the adjustable valve 513 is performed manually, for example according to visual characteristics of the liquid-gaseous mixture released from the outer auxiliary conduit 518. The main conduit 516 enables delivery of the high-quality nitrogen to a target location.

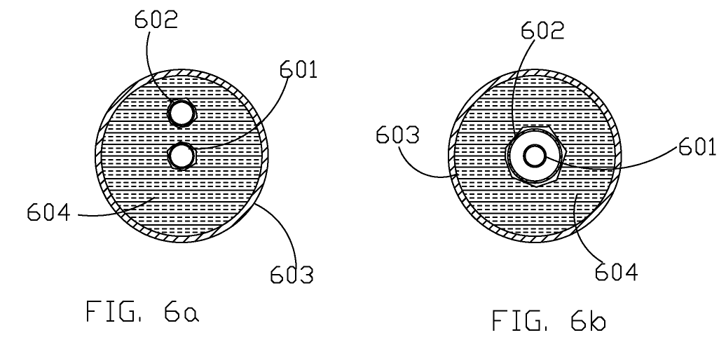

FIG. 6a and FIG. 6b show radial cross-sectional views of two exemplary illustrative implementations for the main and internal auxiliary conduits in the envelope of the hose.

In a first exemplary embodiment shown in FIG. 6a, the main conduit 601 is preferably situated next to the internal auxiliary conduit 602 in envelope 603 and the internal space of envelope 603 is preferably filled with a thermo-insulating filler 604.

In a second exemplary embodiment shown in FIG. 6b, the main conduit 601 is preferably situated coaxially with respect to the internal auxiliary conduit 602 in envelope 603 and the internal space of envelope 603 is preferably filled with the thermo-insulating filler 604.

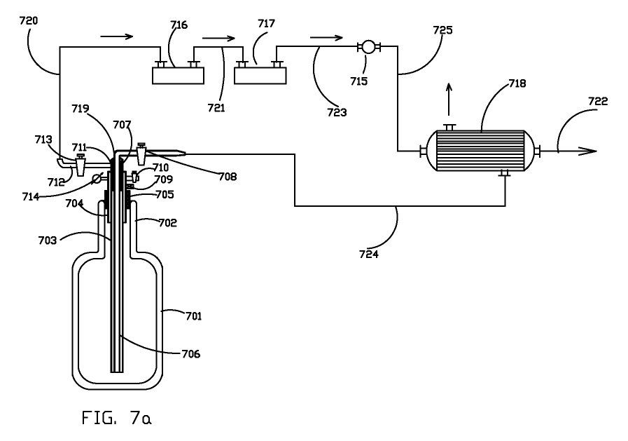

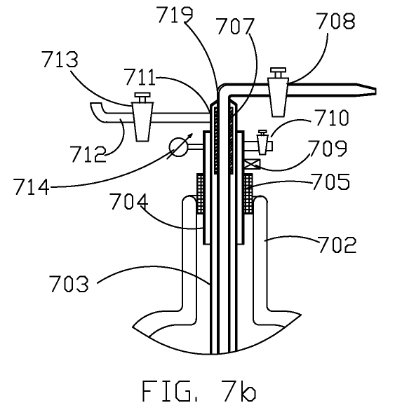

FIG. 7a provides an exemplary, illustrative implementation of a Dewar flask with a siphon according to the present invention, preferably featuring a compression means, a valve means and a heat exchange means intended to provide high pressure pulses of the liquid cryogen. In addition, FIG. 7b shows an enlarged axial cross-sectional view of the upper section of the siphon and the Dewar neck.

This exemplary embodiment comprises: a Dewar flask 701 with neck 702. A siphon comprises an external conduit 703; and a jacket 704 surrounding the upper section of the external conduit 703. The upper edge of jacket 704 is sealed with the external conduit 703. An annular rubber ring 705 is preferably installed on the outer surface of jacket 704 for sealing with neck 702. There is a central feeding conduit 706. A main part of the central feeding conduit 706 is surrounded by the external conduit 703. This central feeding conduit 706 preferably comprises an upper section 719 having an outer surface covered with an absorbent or wettable material, preferably a capillary material 707, more preferably a capillary coating. The upper edge of the external conduit 703 is sealed with the outer section of the central feeding conduit 706.

A shut-off valve 708 is preferably installed on the outer section of the central feeding conduit 706, while safety and relief valves 709 and 710 are preferably installed on ports of the outer section of jacket 704. The outer section of the external conduit 703 is preferably provided with opening 711 which is provided in turn with duct 712, more preferably featuring an adjustable valve 713. A pressure gauge 714 is optionally and preferably installed on the outer section of jacket 704, for measuring the internal pressure in the Dewar flask 701.

The gaseous-liquid cryogenic medium, which flows from duct 712 through pipeline 720, is preferably pressurized by at least one and more preferably a plurality of compressors 716 and 717 arranged in sequence with pipeline 721 communicating between them. The compressed medium then preferably enters through pipeline 723 to a heat exchanger 718 of the recuperative type as it is known in the art, preferably through a controllable valve 715 and more preferably in the form of high pressure pulses. The liquid cryogen at relatively low pressure also preferably enters the heat exchanger 718 through pipeline 724. As the result, the gaseous medium is condensing in the heat exchanger 718, and high pressure pulses of the liquid cryogen are supplied from the output of the heat exchanger 718 through pipeline 722.

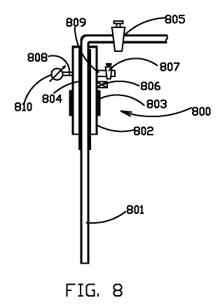

FIG. 8 shows an axial cross-sectional view of another exemplary, illustrative embodiment of a siphon according to the present invention, with thermal insulation of the upper internal section of the central feeding conduit.

The siphon 800 preferably includes a central feeding conduit 801 and jacket 802 surrounding the upper section of the central feeding conduit 801. The upper edge of jacket 802 is sealed with the central feeding conduit 801. An annular rubber ring 803 is preferably present on the outer surface of jacket 802. The upper edge of jacket 802 is sealed with the outer section of the central feeding conduit 801.

A shut-off valve 805 is preferably installed on the outer section of the central feeding conduit 801, while safety and relief valves 806 and 807 are preferably installed on ports 808 and 809 of the outer section of jacket 802. A thermal insulation 804 is installed on the outer surface of the central feeding conduit 801. These components operate as described above.

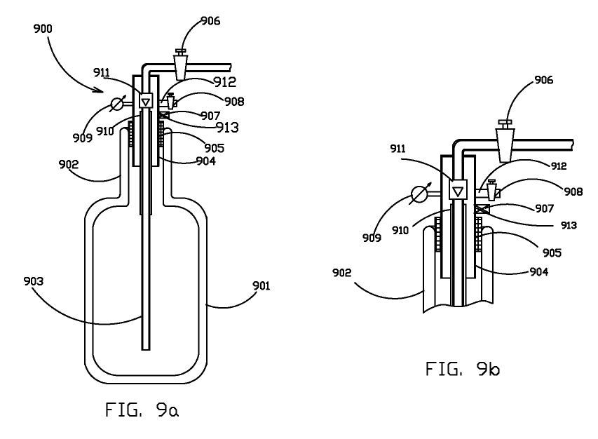

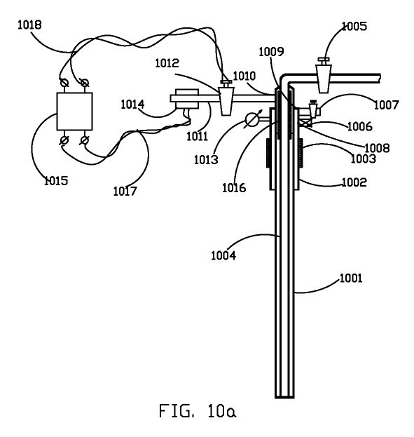

FIG. 9 shows an axial cross-sectional view of some embodiments of a siphon system according to the present invention, comprising a Dewar flask with a siphon installed in its neck; a central feeding conduit of the siphon provided with a vacuum evacuated jacket and a check valve for providing liquid cryogen of a high quality (with a minimal proportion of gas) in the form of pulses.

The siphon system 900 includes: a Dewar flask 901 comprising neck 902 and a central feeding conduit 903. Jacket 904 preferably surrounds the upper section the central feeding conduit 903, while the upper edge of jacket 904 is sealed to the central feeding conduit 903. Optionally and preferably, an annular rubber ring 905 is present on the outer surface of jacket 904.

Optionally and preferably, a shut-off valve 906 is installed on the outer section of the central feeding conduit 903. Also optionally and preferably, safety and relief valves 907 and 908 are installed on ports 912 and 913 of the outer section of jacket 904. Optionally and more preferably, a pressure gauge 909 is installed on the outer section of jacket 904, for measuring the internal pressure in the Dewar flask 901.

The upper section of the central feeding conduit 903 is preferably provided with jacket 910 comprising an internal vacuum. Preferably, a check valve 911 is installed on the upper section of the central feeding conduit 903 in the immediate vicinity to the distal edge of jacket 910.

The system preferably operates as follows: the liquid cryogen enters through the open check valve 911 into the upper section of the central feeding conduit 903. As the result of heat exchange with jacket 904, the liquid cryogen starts to boil, causing an elevation of its pressure and closing the check valve 911. This closing of the check valve 911 causes further elevation of the pressure in the upper section of the central feeding conduit 903 and accelerated propulsion of the liquid cryogen portion outwards.

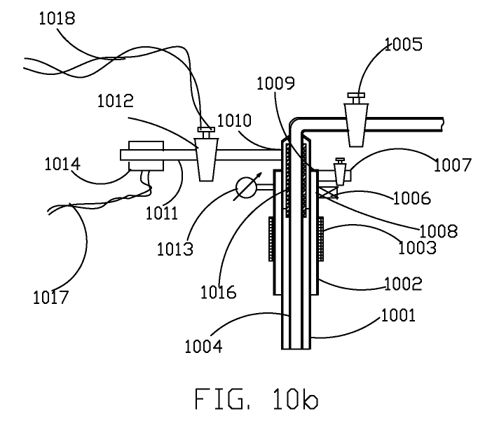

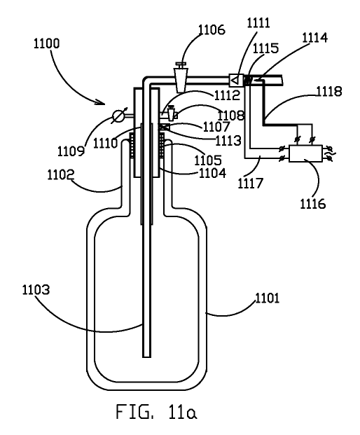

FIG. 10a and FIG. 10b show an axial cross-sectional view of a siphon with a control unit, which is functioning on the base of measuring a density of the mist emitted from the port of the annular gap of the gaseous-liquid mixture released from the annular gap between the external and central feeding conduits (FIG. 10a), and an enlarged axial cross-sectional view of the upper section of the siphon (FIG. 10b).

This embodiment includes an external conduit 1001; jacket 1002 surrounding the upper section of the external conduit 401, wherein the upper edge of jacket 1002 is sealed with the external conduit 1001; an annular rubber ring 1003; a central feeding conduit 1004, wherein the upper section of its outer surface is coated with a capillary coating 1016 and the upper edge of the external conduit 1001 is sealed with the outer section of the central feeding conduit 1004; a shut-off valve 1005, which is installed on the outer section of the central feeding conduit 1004; and safety and relief valves 1006 and 1007, which are installed on ports 1008 and 1009 of the outer section of jacket 1002. The outer section of the external conduit 1001 is provided with port 1010 which is provided in turn with duct 1011. There is an adjustable valve 1012 installed on this duct. A pressure gauge 1013, which is installed on the outer section of jacket 1002, serves for measuring the pressure in the Dewar flask. These components correspond to similar components described with regard to FIGS. 1-3.

The siphon in combination with a dewar flask filled with a liquid cryogen preferably operates as follows. After opening the adjustable valve 1012, the liquid cryogen in the gap between the external conduit 1001 and the central feeding conduit 1004 is elevated to a level which wets the capillary material 1016. The temperature of the upper section of the central feeding conduit 1004 is reduced to the temperature of the liquid cryogen and, after opening the shut-off valve 1005, liquid cryogen of high quality is supplied into the outer section of the central feeding conduit 1004. The level of the liquid cryogen in the gap between the external conduit 1001 and the central feeding conduit 1004 is maintained by the control unit 1015 through cables 1018, which closes and opens the adjustable valve 1012 according to the signal provided by a density sensor 1014 (measuring device) installed on duct 1011; this signal is supplied to the control unit 1015 through cables 1017.

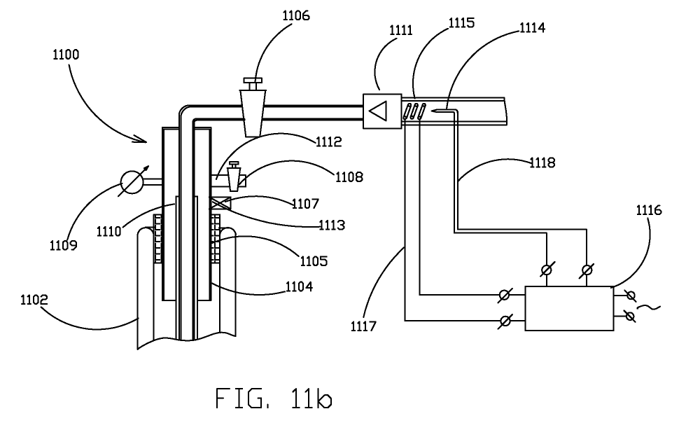

FIG. 11a and FIG. 11b show an axial cross-section of another optional embodiment of a Dewar flask with a siphon installed in its neck (FIG. 11a) and an enlarged axial cross-sectional view of the upper section of the siphon (FIG. 11b), featuring a low inertia temperature sensor, an electrical heater installed in the central feeding conduit and a control-power unit, which generates pulses of electrical current.

The siphon system 1100 includes: a Dewar flask 1101 comprising neck 1102 and a central feeding conduit 1103. Jacket 1104 preferably surrounds the upper section the central feeding conduit 1103, while the upper edge of jacket 1104 is sealed to the central feeding conduit 1103. Optionally and preferably, an annular rubber ring 1105 is present on the outer surface of jacket 1104.

Optionally and preferably, a shut-off valve 1106 is installed on the outer section of the central feeding conduit 1103. Also optionally and preferably, safety and relief valves 1107 and 1108 are installed on ports 1112 and 1113 of the outer section of jacket 1104. Optionally and more preferably, a pressure gauge 1109 is installed on the outer section of jacket 1104, for measuring the internal pressure in the Dewar flask 1101.

The upper section of the central feeding conduit 1103 is preferably provided with jacket 1110 comprising an internal vacuum. Preferably, a check valve 1111 is installed on the upper section of the central feeding conduit 1103 in the immediately after the check valve 1111. There is a low inertia electrical heater 1115 installed immediately after the check valve 1111. A low inertia temperature sensor 1114 is preferably installed in the central feeding conduit 1103. Delivery of a portion of the liquid cryogen via the check valve 1111 lowers the temperature measured by low inertia thermocouple 1114 (as an example of a temperature measuring device), which sends a signal via cables 1118 into a control-power unit 1116. This control-power unit 1116 preferably generates a pulse of electrical current, which is provided via cable 1117 to the low inertia electrical heater 1115, thereby causing the liquid cryogen to boil, preferably through flash boiling, followed by a sharp elevation of its pressure. As a result, the check valve 1111 closes and the high pressure portion of the liquid-gaseous cryogen is emitted.

While the invention has been described with respect to a limited number of embodiments, it will be appreciated that many variations, modifications and other applications of the invention may be made and still be within the spirit and scope of the invention.

We claim:

1. A siphon for feeding liquid cryogen from a Dewar flask, comprising:
a central feeding conduit;
an external conduit containing said central feeding conduit;
seal means sealing said external conduit to the Dewar flask;
seal means sealing said central feeding conduit with said external conduit; and
capillary means situated between upper sections of said central feeding and external conduits;
wherein the liquid cryogen is fed through said central feeding conduit from the Dewar flask.

2. The siphon of claim 1, wherein said external conduit surrounds a significant portion of said central feeding conduit.

3. The siphon of claim 1, further comprising at least one shut-off valve on an outside section of said central feeding conduit.

4. The siphon of claim 3, wherein said outside section of said external conduit including at least one port and at least one valve for releasing a gaseous-liquid cryogenic mixture from a space between said central feeding and external conduits.

5. The siphon of claim 1, wherein said seal means sealing said external conduit to the Dewar flask comprises a jacket surrounding the upper section of the external conduit, wherein an upper edge of said jacket is sealed with the external conduit; said jacket being provided with sealing means for installation of said siphon in the neck of said Dewar flask.

6. The siphon of claim 5, wherein said sealing means of said jacket being a rubber ring installed on an outer surface of said jacket.

7. The siphon of claim 5, wherein said jacket is provided with ports; and further comprising a pressure gauge for measuring pressure of the cryogen, a safety valve and a release valve communicating with a respective one of said ports of said jacket for reducing said pressure of the cryogen.

8. The siphon of claim 5, wherein said jacket is provided with a port for introducing a suppressed gas into the Dewar flask.

9. The siphon of claim 5, further comprising a gap between said jacket and said external conduit for increasing hydraulic resistance of cryogen flow.

10. The siphon of claim 1, further comprising a measuring means for determining a level of said liquid cryogen in a space between said external and central feeding conduits.

11. The siphon of claim 10, wherein said measuring means comprises a level gauge situated in said space between said external and central feeding conduits.

12. The siphon of claim 10, wherein said measuring means comprises a temperature measuring device for measuring the temperature of the gaseous-liquid medium.

13. The siphon of claim 12, wherein said temperature measuring device measures temperature of the gaseous-liquid medium released from the space between said central feeding conduit and said external conduit.

14. The siphon of claim 10, wherein said measuring means comprises an optical measuring device for measuring density of an exhausted medium.

15. The siphon of claim 14, wherein said optical measuring device measures density of an exhausted medium from the space between said central feeding conduit and said external conduit.

16. The siphon of claim 10, wherein said measuring means comprises an acoustical measuring device for measuring density of an exhausted medium.

17. The siphon of claim 16, wherein said acoustical measuring device measures density of an exhausted medium from the space between said central feeding conduit and said external conduit.

18. The siphon of claim 3, further comprising a control unit for controlling opening of said valve according to a measured level.

19. The siphon of claim 3 wherein said valve is controlled manually.

20. The siphon of claim 1, wherein said central feeding conduit comprises a filter.

21. The siphon of claim 1, further comprising a hose transporting liquid cryogen from the Dewar flask.

22. The siphon of claim 21, wherein said hose comprises an envelope and a main conduit in flow communication with said central feeding conduit.

23. The siphon of claim 21, wherein said hose further comprises an internal auxiliary conduit intended for the exhausted gaseous-liquid mixture from the space between said central feeding conduit and said external conduit; the distal end of said internal auxiliary conduit being in flow communication with an outer auxiliary conduit for releasing said cryogen into the atmosphere.

24. The siphon of claim 21, wherein said hose further comprises a thermo-insulating filler for filling an internal space between said main conduit and internal auxiliary conduit, and said envelope.

25. The siphon of claim 22, wherein said main and internal auxiliary conduits are arranged side by side in said envelope of said hose.

26. The siphon of claim 22, wherein said main and internal auxiliary conduits are arranged coaxially in said envelope of said hose.

27. The siphon of claim 3, further comprising a check valve and a heat exchanger, said check valve being communicably connected to said central feeding conduit and said heat exchanger being communicably connected to said check valve.

28. The siphon of claim 27, wherein said heat exchanger comprises an upper section of said central feeding conduit, said upper section of said central feeding conduit communicating between said check valve and shut-off valves.

29. The siphon of claim 28, further comprising thermal insulation around the upper section of said central feeding conduit.

30. The siphon of claim 29, wherein said thermal insulation being a vacuum insulation.

31. The siphon of claim 27, wherein said check valve is installed after the shut-off valve in the direction of flow; and further comprising a low inertia electrical heater installed immediately after said check valve in the direction of flow; a low inertia temperature sensor installed in the central feeding conduit; and a control power unit receiving signals from said low inertia temperature sensor and generating pulses of electrical current provided to said low inertia electrical heater.

32. The siphon of claim 31, wherein said low inertia temperature sensor is a low inertia thermocouple.

33. The siphon of claim 3, further comprising a compressor in communication with a port of said external conduit, said compressor elevating a pressure of said cryogen exhausted from said port; and a heat exchanger of the recuperative type cooling and condensing the compressed gas from said compressor by the liquid cryogen provided through the central feeding conduit.

34. The siphon of claim 33, further comprising a valve which supplies said liquid cryogen in the form of a plurality of high pressure pulses.

35. A siphon for feeding liquid cryogen from a Dewar flask, comprising:
a central feeding conduit;
a thermal insulation around the upper section of said central feeding conduit; and
seal means for sealing said central feeding conduit to the Dewar flask;
wherein the liquid cryogen is fed through said central feeding conduit from the Dewar flask.
